(19) United States
(12) Patent Application Publication
(10) Pub. No.: US 2006/0026905 A1
(43) Pub. Date: Feb. 9, 2006

(54) Preparation of coated abrasive disk

(75) Inventor: Yong Bum Kim, Siheung-si (KR)

Correspondence Address: David A. Einhorn, Esq.;Anderson Kill & Olick, P.C., 1251 Avenue of the Americas, New York, NY, 10020, US

(73) Assignee: Suntek Industries, Ltd.

(21) Appl. No.: 11/246,975

(22) Filed: Oct. 7, 2005

Related U.S. Application Data
(63) Continuation-in-part of application No. 10/775,297, filed on Feb. 9, 2004.

(30) Foreign Application Priority Data
Dec. 9, 2003 (KR) 2003-0088951

(51) Int. Cl. C09K 3/14

(52) U.S. Cl. 51/298

(57) ABSTRACT

A coated abrasive disk having an improved dimensional stability, high adhesion strength and high breaking strength is prepared by combining together (A) a nonwoven fabric, (B) at least one textile made of microfibers in a pre-dried state after impregnation-treatment with an adhesive resin, and (C) a coated abrasive body comprised of a backsheet and a coated abrasive layer, by means of a pressure.

### CROSS-REFERENCE TO RELATED APPLICATION

This application is a continuation-in-part of U.S. patent application Ser. No. 10/775,297, filed on Feb. 9, 2004, now abandoned.

### FIELD OF THE INVENTION

The present invention relates to a method for preparing a light coated abrasive disk having an improved dimensional stability, high adhesion strength and high breaking strength.

### BACKGROUND OF THE INVENTION

Conventional coated abrasive disks comprising a vulcanized fiber substrate shown in FIG. 1 are prepared by coating an adhesive resin on the vulcanized fiber substrate to form a first adhesive layer, spreading a layer of an abrasive material thereon, pre-drying, coating the abrasive layer with a second layer of an adhesive resin and drying the coated layer.

Such a method to form directly on a substrate an abrasive body comprised of a first adhesive layer, an abrasive material layer and a second adhesive layer, however, has a problem in that the shape of the substrate may become distorted by heat during the drying process of the abrasive layer, resulting in a poor product quality. In addition, this method requires a post-treatment, i.e., humidification, step to impart dimensional stability to the final abrasive disk.

### SUMMARY OF THE INVENTION

Accordingly, it is a primary object of the present invention to provide a simple method for preparing a coated abrasive disk that obviates a humidification treatment of the final product; and a coated abrasive disk prepared by said method, which is light, and has an improved dimensional stability, high elasticity, high adhesion strength and high breaking strength.

In accordance with one aspect of the present invention, there is provided a method for preparing a coated abrasive disk which comprises steps of:

(1) preparing a disk form of a coated abrasive body comprised of a backsheet and a layer of an abrasive material thereon,

(2) placing disk forms of a nonwoven fabric, at least one textile and the coated abrasive body in order into a mold such that the backsheet of the coated abrasive body faces the textile, wherein the textile is made of microfibers having a diameter of 5 to 13 μm and is in a pre-dried state after impregnation-treatment with an adhesive resin, and

(3) applying a pressure to a stack of the nonwoven fabric, textile and coated abrasive body to combine them.

In accordance with another aspect of the present invention, there is provided a coated abrasive disk which has a structure comprising a nonwoven fabric, at least one textile layer, a backsheet and a coated abrasive layer which are sequentially stacked.

### BRIEF DESCRIPTION OF THE DRAWINGS

The above and other objects and features of the present invention will become apparent from the following description of the invention, when taken in conjunction with the accompanying drawings, which respectively show:

FIG. 1: a schematic diagram of a conventional coated abrasive disk;

FIG. 2: a schematic diagram of a coated abrasive disk in accordance with the present invention;

FIG. 3: a schematic diagram of a roll coater for coating an adhesive on a substrate; and

FIG. 4: a longitudinal cross-sectional view of a sloping mold having a shaft at its center.

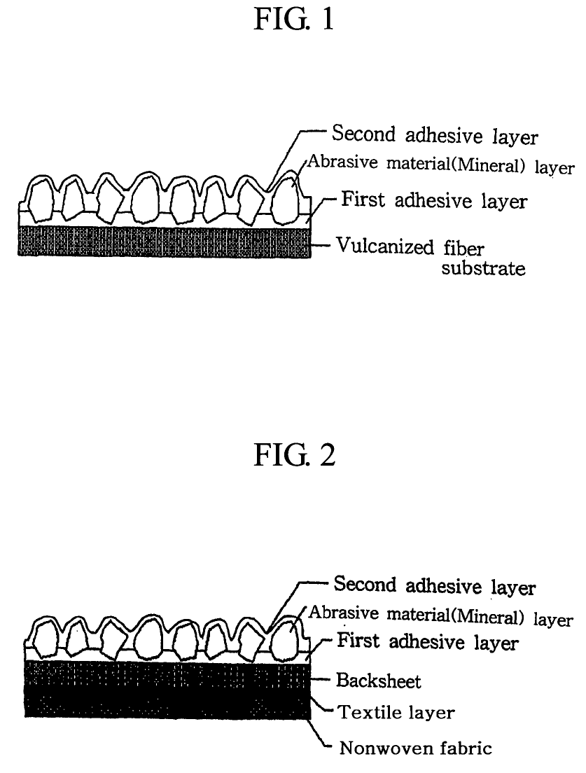

### DETAILED DESCRIPTION OF THE INVENTION

The inventive method for preparing a coated abrasive disk is characterized by combining together three elements of (A) a nonwoven fabric, (B) at least one textile, and (C) a coated abrasive body comprised of a backsheet and a coated abrasive layer by means of a pressure, and, on the combination, using the textile made of microfibers in a pre-dried state after impregnation-treatment with an adhesive resin. The resulting coated abrasive disk is further illustrated in FIG. 2.

The textile which is employed in the present invention is made of microfibers having a small diameter ranging from 5 to 13 μm, as compared that a textile for use in preparing a coated abrasive disk is conventionally made of fibers with a diameter of 30 to 35 μm. The inventive microfiber textile results in lowering of both weight and thickness of a final coated abrasive disk, thereby improving working circumstance, and further, it leads to enhancement of interlayer adhesive ability, i.e., adhesion strength, and breaking strength thereof.

In addition, the textile which is employed in the present invention is impregnation-treated with an adhesive resin such as a phenol resin, a mixture of a phenol resin and an acrylonitrile-butadiene-rubber latex, polyvinyl butyral, an epoxy resin or urea melamine, and a degenerated heat-curable resin, and then is pre-dried. The adhesive resin may be incorporated into the textile in an amount ranging from 160 to 220 g/m². The pre-drying of the impregnation-treated textile may be performed at a temperature ranging from 140 to 160° C. for 2 to 3 min.

Representative examples of the textile may include glass fiber, carbon fiber, polyester and nylon textiles. Preferably, the carbon fiber and glass fiber textiles are impregnation-treated with a phenol resin, and the polyester and nylon textiles are impregnation-treated with a mixture of a phenol resin and an acrylonitrile-butadiene-rubber latex, e.g., a mixture of 70 to 90 weight % of a phenol resin and 10 to 30 weight % of an acrylonitrile-butadiene-rubber latex.

The carbon fiber textile and the reticular glass fiber textile are made of 48˜70 s/yarn ×25˜30 s/yarn (Warp×Fill) and 5˜16 s/yarn ×5˜16 s/yarn (Warp×Fill) fibers, respectively. In addition, the polyester and nylon textiles are both made of 5˜16 s/yarn ×5˜16 s/yarn (Warp×Fill) fibers.

The coated abrasive disk in accordance with the present invention is manufactured by placing a nonwoven fabric, said at least one textile, and a coated abrasive body comprised of a backsheet and a layer of a coated abrasive material thereon in order from the bottom into a mold heated at a temperature ranging from 140 to 170° C. such that the backsheet of the coated abrasive body faces the textile, and then applying a pressure of 6 to 9 kgf/cm² thereto for 4 to 6 hrs. The respective nonwoven fabric, textile and coated abrasive body are pre-cut in the form of a disk. The use of the pre-dried textile makes a further use of an adhesive for combination unnecessary, preventing increasing of the weight of a final coated abrasive disk.

To be used in an abrasion, the prepared coated abrasive disk must fit to an abrasive pad fixed to an abrasive tool. Since the conventional abrasive pad is a disk shaped structure with slight indentation therein, it is preferred that a mold is slanted towards its center as well. The inclination of the mold is dependent on the precise shape of the abrasive pad but is generally in the range of 5 to 9°. One embodiment of such a mold having a shaft at its center is shown in FIG. 4. Slant structure of a coated abrasive disk alleviates vibration generated during the course of abrasion to make high precision abrasion possible and workers comfortable.

The coated abrasive body which may be employed in the present invention is prepared by a method described below. First, a backsheet may be prepared by coating an adhesive, e.g., a phenol resin, an acrylonitrile-butadiene-rubber latex and a mixture thereof, on both sides of a material selected from the group consisting of polyester textile, cotton textile, polyester/cotton mixed textile (e.g., polyester yarn:cotton yarn=65:35, 50:50), polyester/nylon mixed textile (e.g., polyester yarn:nylon=50:50), polyester film (PET film) and cylinder paper. Then, a coated abrasive body may be prepared by coating a first adhesive mixture on the prepared backsheet, spreading an abrasive material thereon, drying at a temperature ranging from 60 to 110° C. for 1 to 3 hrs, coating and drying a second adhesive mixture thereon at a temperature ranging from 70 to 120° C. for 150 to 240 min to form a second adhesive layer, and cutting the coated abrasive body in a desired disk form.

The first and second adhesive mixtures are mixtures of an adhesive and a filler having a weight mix ratio of 50:50 and 40:60, respectively, and may be coated by a conventional method and, if necessary, roll-coated. The adhesive may be a conventional adhesive such as a phenol resin; and a conventional inorganic filler such as CaCO₃ may be employed.

Representative abrasive materials which may be employed in the present invention include alumina (Al₂O₃), silicon carbide (SiC), alumina zirconia (AZ), ceramics, diamond, CBN (cubic boron nitrile) and a mixture thereof. Such an abrasive material preferably has a particle size of 16 to 180 mesh and may be dispersed on the first adhesive layer by a conventional electric or dropping coating method.

The inventive abrasive disk may be made in a commercially desirable disk form, e.g., 4″, 4+½″, 5″ and 7″.

The following Examples and Comparative Examples are given for the purpose of illustration only, and are not intended to limit the scope of the invention.

### EXAMPLE 1

Cut into a disk form having an outer diameter of 180 mm and an inner diameter of 23 mm were a 20 to 30 g/m² nonwoven fabric (polyester nonfabric commercially available from Kolon); one carbon fiber textile (commercially available from Korea Fiber Company) made of microfibers with a diameter of 11 μm and composed of 58 s/yarn×30 s/yarn (Warp×Fill) fibers; and one reticular glass fiber textile (commercially available from Korea Fiber Company) made of microfibers with a diameter of 11 μm and composed of 8 s/yarn×8 s/yarn (Warp×Fill) fibers. The carbon and glass fiber textiles were impregnation-treated with Novolak phenol resin and pre-dried at 150° C. for 3 min. The amount of the Novolak phenol resin incorporated into each of the textiles was 500 g/m².

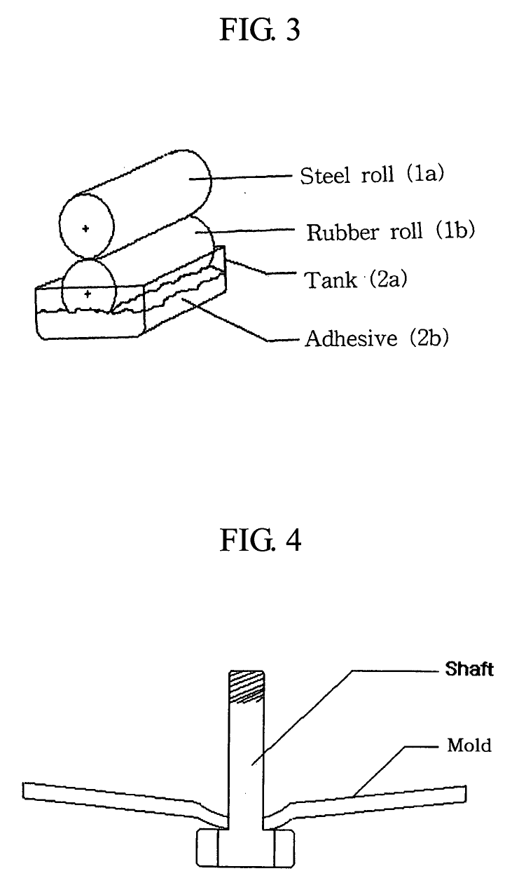

Then, a backsheet was prepared by processing a polyester film (PET film) and coating a phenol resin adhesive compounded with an acrylonitrile-butadiene-rubber latex on the both sides thereof. On the backsheet, a 50:50 (weight ratio) mixture of a phenol resin and CaCO₃ was coated in an amount of 260 g/m², alumina particles having a particle size of 24 mesh were spread in an amount of 900 g/m², and dried at a temperature of 90 to 95° C. for 1.5 hrs to form a first adhesive layer having the abrasive material dispersed therein. A 40:60 (weight ratio) mixture of a phenol resin and CaCO₃ was coated thereon in an amount of 500 g/m², and dried at a temperature of 90 to 95° C. for 4 hrs to form a second adhesive layer. The coating of the first and second adhesive layers was performed by a roll coater shown in FIG. 3.

The prepared coated abrasive body was cut into a disk form having an outer diameter of 180 mm and an inner diameter of 23 mm. The nonwoven fabric, pre-dried carbon fiber textile, pre-dried glass fiber textile and coated abrasive body disks were sequentially stacked from the bottom in a steel mold heated to 150° C., and pressed at a force of 7.0 kgf/cm² for 4 hrs, to combine together them, thereby yielding the coated abrasive disk in accordance with the present invention. The steel mold with a shaft at its center had a disk form having an outer diameter of 180 mm and an inner diameter of 23 mm, and an inclination of 6° towards the center, as shown in FIG. 4. No separate post-treatment of humidification was performed.

### EXAMPLE 2

The procedure of Example 1 was repeated except that three glass fiber textiles were cut and used, to prepare the inventive coated abrasive disk.

### EXAMPLE 3

The procedure of Example 1 was repeated except that five carbon fiber textiles were cut and used, and no glass fiber textile was used, to prepare the inventive coated abrasive disk.

### EXAMPLE 4

The procedure of Example 1 was repeated except that six glass fiber textiles were cut and used, and no carbon fiber textile was used, to prepare the inventive coated abrasive disk.

### COMPARATIVE EXAMPLE 1

A 0.85 mm thick vulcanized fiber substrate (GBR 0.85 mm, commercially available from Toyo Fiber Company, Japan) was cut into a disk form having an outer diameter of 180 mm and an inner diameter of 23 mm. A first adhesive layer having an abrasive material dispersed therein and a second adhesive layer were formed directly on the cut substrate in accordance with the same method as in Example 1. Then, water was spread on the substrate surface with a brush and left for 7 days within an aging room kept at a temperature ranging from 25 to 30° C. and a relative humidity ranging from 70 to 80%, to prepare the conventional coated abrasive disk.

### COMPARATIVE EXAMPLE 2

The procedure of Example 1 was repeated except that used were the carbon fiber textile (commercially available from Korea Fiber Company) made of fibers with a diameter of 30 μm and the glass fiber textile (commercially available from Korea Fiber Company) made of fibers with a diameter of 30 μm, to prepare a coated abrasive disk.

Characteristics Test

The characteristics of the respective abrasive disks obtained in Examples 1 to 4, and Comparative Examples 1 and 2 were measured in terms of tensile strength, rotation breaking strength and adhesion strength, and the results are shown in Table 1.

TABLE 1

| | Coated Abrasive Disk | | | | | |
|---|---|---|---|---|---|---|
| | Ex. 1 | Ex. 2 | Ex. 3 | Ex. 4 | Comp. Ex. 1 | Comp. Ex. 2 |
| Tensile Strength | 250˜280 | 280˜320 | 350˜400 | 320˜350 | 150˜200 | 250˜280 |
| (kgf/in)*¹ | | | | | | |
| Rotation Breaking | 30,000˜33,000 | 30,000˜33,000 | 30,000˜33,000 | 32,000˜35,000 | 15,000˜18,000 | 22,000˜25,000 |
| Strength (rpm)*² | | | | | | |
| Adhesion Strength | 7 | 8 | 8 | 8 | 6 | 5 |
| (kgf/2 inch · width)*³ | | | | | | |

Note:
*¹Tensile strength-measuring instrument - LLOYD Instruments type LR5R
*²rpm value measured when broken
*³Pull-push scale FB-50K - Imada Corporation, Japan

As can be seen from Table 1, the inventive abrasive disks of Examples 1 to 4 exhibit improved properties in terms of tensile strength, rotation breaking strength and adhesion strength, as compared to the abrasive disks of Comparative Examples 1 and 2.

As described above, the present invention provides a simple and economical method for preparing without a humidification treatment a light coated abrasive disk having an improved dimensional stability, high elasticity, high adhesion strength, and high resistance against breakage by load or rapid rotation during the course of usage, which is useful for various applications including removal of rust from a ship steel, grinding of metal welding sites and removal of old car paint.

While the invention has been described with respect to the above specific embodiments, it should be recognized that various modifications and changes may be made to the invention by those skilled in the art which also fall within the scope of the invention as defined by the appended claims.

What is claimed is:

1. A method for preparing a coated abrasive disk which comprises steps of:
(1) preparing a disk form of a coated abrasive body comprised of a backsheet and a layer of an abrasive material thereon,
(2) placing disk forms of a nonwoven fabric, at least one textile and the coated abrasive body in order into a mold such that the backsheet of the coated abrasive body faces the textile, wherein the textile is made of microfibers having a diameter of 5 to 13 μm and is in a pre-dried state after impregnation-treatment with an adhesive resin, and
(3) applying a pressure to a stack of the nonwoven fabric, textile and coated abrasive body to combine them.

2. The method of claim 1, wherein the textile is selected from the group consisting of glass fiber, carbon fiber, polyester and nylon textiles.

3. The method of claim 1, wherein the adhesive resin is selected from the group consisting of a phenol resin, a mixture of a phenol resin and a material selected from the group consisting of an acrylonitrile-butadiene-rubber latex, polyvinyl butyral, an epoxy resin and urea melamine, and a degenerated heat-curable resin.

4. The method of claim 1, wherein the adhesive resin is incorporated into the textile in an amount ranging from 160 to 220 g/m² by impregnation-treatment.

5. The method of claim 1, wherein the pre-drying of the impregnation-treated textile is performed at a temperature ranging from 140 to 160° C. for 2 to 3 min.

6. The method of claim 1, wherein in step (3), a pressure of 6 to 9 kgf/cm² is applied to the stack at a temperature ranging from 140 to 170° C.

7. The method of claim 1, wherein the mold is slanted towards its center.

8. The method of claim 7, wherein the inclination of the mold is in the range of 5 to 9°.

9. The method of claim 1, wherein the coated abrasive body is prepared by coating a first adhesive mixture on the backsheet, spreading an abrasive material thereon, drying the first adhesive layer having the abrasive material dispersed therein, coating a second adhesive mixture thereon and drying the second adhesive layer.

10. The method of claim 1, wherein the backsheet is a processed material selected from the group consisting of polyester textile, cotton textile, polyester/cotton mixed textile, polyester/nylon mixed textile, polyester film (PET film) and cylinder paper.

11. The method of claim 1, wherein the abrasive material is selected from the group consisting of alumina (Al₂O₃), silicon carbide (SiC), alumina zirconia (AZ), ceramics, diamond, CBN (cubic boron nitrile) and a mixture thereof.

12. A coated abrasive disk prepared by the method of claim 1.
